(19) United States
(12) Patent Application Publication
(10) Pub. No.: US 2006/0236587 A1
(43) Pub. Date: Oct. 26, 2006

(54) Device for storing bait rigs and methods of use thereof

(76) Inventor: Mark Rankine, Rensselaer, NY (US)

Correspondence Address: SCHMEISER, OLSEN & WATTS, 22 CENTURY HILL DRIVE, SUITE 302, LATHAM, NY, 12110, US

(21) Appl. No.: 11/384,983

(22) Filed: Mar. 20, 2006

Related U.S. Application Data
(60) Provisional application No. 60/674,517, filed on Apr. 25, 2005.

(51) Int. Cl. A01K 97/06

(52) U.S. Cl. 43/25.2; 43/57.2

(57) ABSTRACT

A storage device for bait rigs comprising a securing element having indentations for storing bait rigs by winding around the body and securing the hooks. The storage device may be used alone or it may be attached to a fishing pole with a bait rig installed to prevent tangling when not in use. When the storage device is attached to a fishing pole an optional case may surround the storage device for further protection from tangling.

### CROSS REFERENCE TO RELATED APPLICATIONS

This application claims benefit to U.S. Provisional Ser. No. 60/674,517 filed Apr. 25, 2005, the contents of which are incorporated in their entirety.

### FIELD OF THE INVENTION

The present invention relates to the field of bait rigs, and devices and methods for storage thereof.

### BACKGROUND OF THE INVENTION

Fishing poles having bait rigs attached are used to catch fish bait in large volumes efficiently and quickly. Typically the bait rigs have multiple lines each with hooks varying in size and number. After use, the fishing poles typically are unable to be stored with the bait rigs still attached. Due to the length and number of the bait rig lines as well as the attached hooks, the bait rig often gets entangled with itself as well as the fishing pole. This disadvantage essentially renders the bait rigs as one-time-use or as disposable fishing accessories. They are difficult to store with a fishing pole without some entanglement occurring. Therefore a need exists for devices and methods for storage of bait rigs thereof that overcome at least one of the aforementioned deficiencies.

### SUMMARY OF THE INVENTION

A first aspect of the present is a device comprising: a securing element having a body with a fitting, wherein said fitting of said securing element is removably attachable to a fishing pole.

A second aspect of the present invention is a device comprising: a case removably attachable to a fishing pole, said fishing pole having a bait rig attached and wherein said case encloses a portion of said fishing pole having said bait rig.

A third aspect of the present invention is a method for storing bait rigs comprising: providing a securing element, wherein said securing element is removably attachable to a fishing pole, said fishing pole having a bait rig attached; attaching said securing element to a portion of said fishing pole; securing said bait rig to said securing element; providing a case removably attachable to said fishing pole; and enclosing said securing element having said bait rig and the portion of said fishing pole having said securing element within said case.

### BRIEF DESCRIPTION OF DRAWINGS

The features of the invention are set forth in the appended claims. The invention itself, however, will be best understood by reference to the following detailed description of an illustrative embodiment when read in conjunction with the accompanying drawings, wherein:

FIG. 1 depicts an embodiment of a perspective view of a securing element, in accordance with the present invention;

FIG. 2 depicts an embodiment of a perspective view of a case, in accordance with the present invention;

FIG. 3 depicts a perspective view of a bait rig, in accordance with the present invention;

FIG. 4 depicts an embodiment of a perspective view of the securing element in use, in accordance with the present invention;

FIG. 5 depicts an embodiment of a perspective view of a case in use, in accordance with the present invention; and

FIG. 6 depicts a second embodiment of a perspective view of a case in use, in accordance with the present invention.

### DETAILED DESCRIPTION OF THE INVENTION

Although certain embodiments of the present invention will be shown and described in detail, it should be understood that various changes and modifications may be made without departing from the scope of the appended claims. The scope of the present invention will in no way be limited to the number of constituting components, the materials thereof, the shapes thereof, the relative arrangement thereof, etc, and are disclosed simply as an example of an embodiment. The features and advantages of the present invention are illustrated in detail in the accompanying drawing, wherein like reference numerals refer to like elements throughout the drawings. Although the drawings are intended to illustrate the present invention, the drawings are not necessarily drawn to scale.

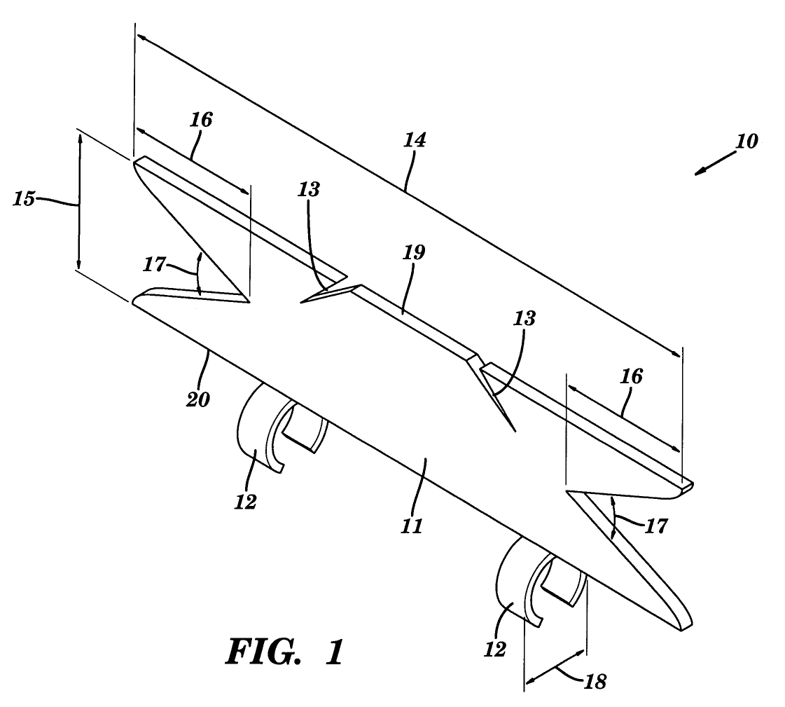

FIG. 1 depicts an embodiment of a perspective view of a securing element 10, in accordance with the present invention. Referring to FIG. 1, the securing element 10 may comprise a body 11, fittings 12, and line catches 13. The body 11 may have a length 14 in a range from about 2 inches to about 6 inches and a height 15 in a range from about 0.5 inches to about 1 inch. The body 11 may be used for wrapping bait rig line around.

The body 11 may have a form that includes general shapes selected from the group consisting of obloids, trapezoids, rectangles, squares, ellipses, circles, and combinations thereof. The body 11 may have indentations 16 on either side of the body 11. The indentations or angled cutouts are at the ends of the body 11 that may form a bowl or lip to accept the bait rig line. The indentations 16 may form an angle 17 that that may be in a range from about 15° to about 45°. The indentations 16 may allow the bait rig line to be generally located at the vertex of the angle 17 when the bait rig line is wrapped around the body 11. The body 11 may be comprised of materials selected from the group consisting of steel, aluminum, brass, copper, plastic, ceramics, wood, natural materials, synthetic materials, composites and combinations thereof.

The fittings 12 may extend outward from and below the body 11. The fittings 12 can secure the body 11 to an object that generally conforms to the fittings 12. Object shapes that the fittings 12 may be adapted to fit are selected from a group consisting of cylindrical shapes, rectangular shapes, semi-cylindrical, semi-rectangular, and combinations thereof. The fittings 12 may be selected from a group consisting of friction fittings, snap fittings, clip fittings, and combinations thereof. The securing element fittings 12 may be a resilient member that snaps onto the portion of the fishing pole such as a metal or plastic that elastically deforms when pressed onto or removed from the shaft of the fishing pole.

The line catches 13 may be slots that extend through the width 18 of the body 11 and extend partially downwards from the top 19 of the body 11 to the bottom 20 of the body 11. The slots may be a narrow opening, a groove, a slit, a gap, and combinations thereof that allow bait rig to securely fit within the slots.

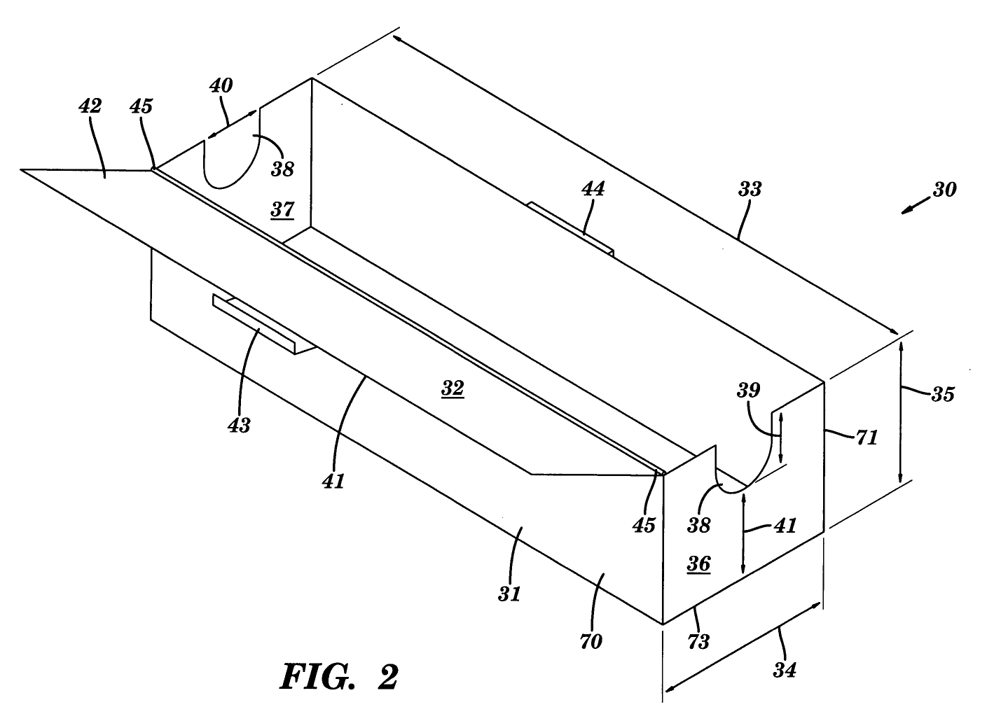

FIG. 2 depicts an embodiment of a perspective view of a case 30, in accordance with the present invention. Referring to FIG. 2, the case 30 may comprise a case body 31 having two sides 70, 71, a bottom 73 and a panel 32. The body 31 may be a rectangular shaped box. The body 11 may have a length 33 in a range from about 4 inches to about 7 inches, a width 34 in a range from about 1 inch to about 3 inches, and a depth 35 in a range from about 1 inch to about 3 inches.

The body 11 may have ends 36, 37 opposite to each other wherein each end, 36 and 37, may have an indentation 38. The indentations 38 may be shaped as concave cuts into an edge of the ends 36 and 37. The indentations 38 may be parabolic shaped segments, open-ended obrounds, and the like. The indentations 38 have a depth 39 in a range from about ¼ inch to about 1 inch and a width 40 in a range from about ¼ inch to about 1 inch. The bottom of the indentations 38 may be a distance 41 from the edges of the ends 36 and 37. The distance 41 may be in a range from about ½ inch to about ⅞ inch.

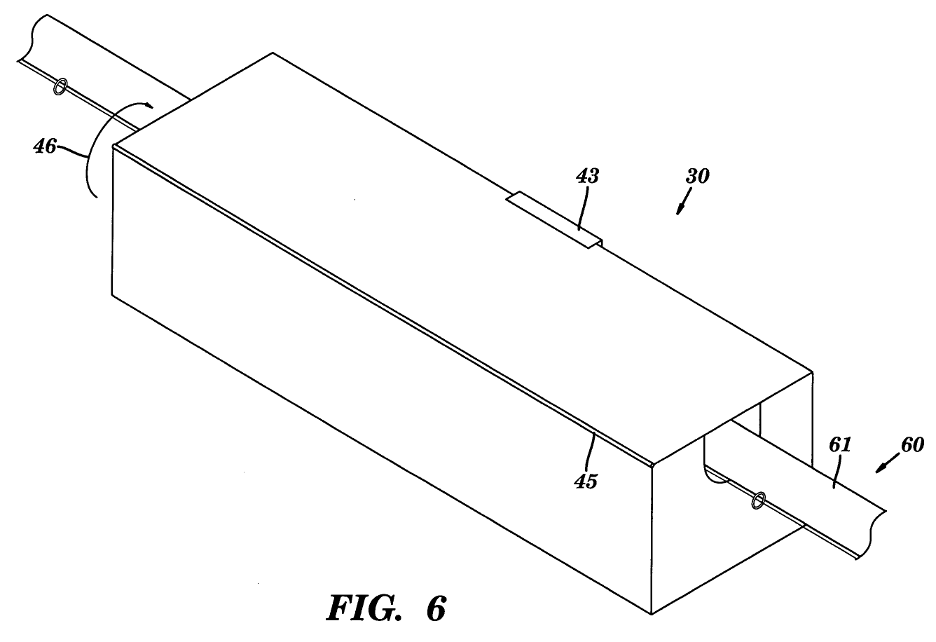

The panel 32 may be generally shaped as a rectangle. Accordingly, the panel 32 may have length and width dimensions similar to the dimensions of the body 11 as to allow the panel 32 to fit over the body 11. For example, the panel 32 may have a length 41 in a range from about 4 inches to about 7 inches and a width 42 in a range from about 1 inch to about 3 inches. The panel 32 further may have attached a handle 43 for opening and closing the panel 32, and a panel catch 44 to allow the handle 43 to lock the panel 42 in a closed position (see FIG. 6). The panel 42 may rotate between an open position and a closed position (see FIG. 6) via a hinge 43. The panel 42 may be further secured by a snap, rubber strap like a bungee cord, hooks and loops fastener (Velcro®) or a strap having a buckle or a clasp.

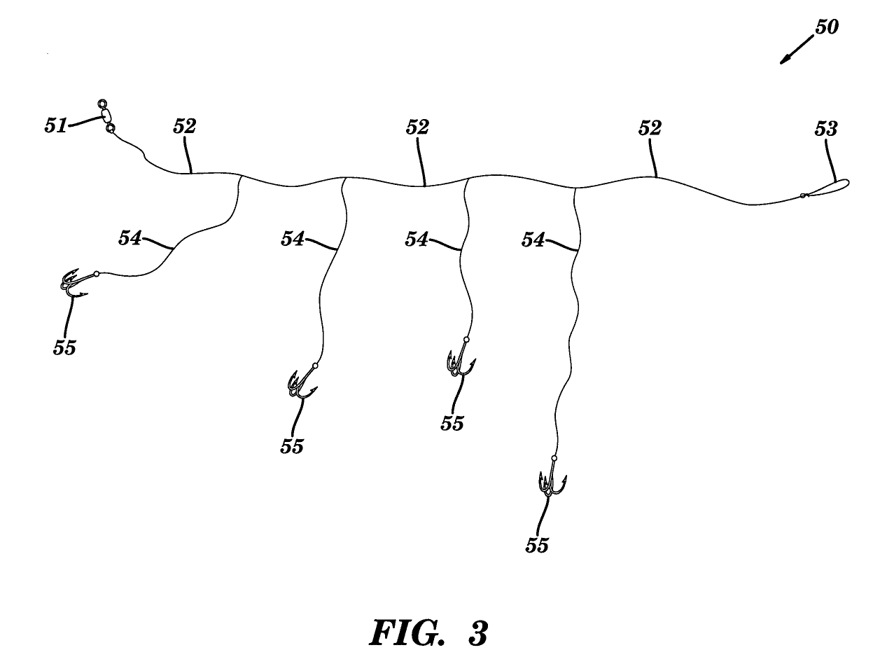

FIG. 3 depicts a perspective view of a bait rig 50, in accordance with the present invention. Referring to FIG. 3, the bait rig 50 may comprise a main line tie 51, a bait rig main line 52, a sinker snap 53, bait rig hook lines 54, and hooks 55. The bait rig 50 configuration previously described is not meant to limit the configuration of bait rigs that may be used in an embodiment of the present invention. Bait rigs having any combination of the types and number of main line ties, sinker snaps, bait rig hook lines, hooks, and float snaps may be used in accordance with devices and methods of the present invention, as described infra. Examples of bait rigs include but are not limited to Hayabusa Sabiki™ rigs, Bleeding Bait™ rigs, Sea Striker™ rigs, and the like.

The main line tie 51 may facilitate attachment of the bait rig 50 to a fishing pole or fishing pole line. The main line 52 may have a length in a range from about 55 inches to about 60 inches with a line strength in a range from about 12 pounds (lbs) to about 30 lbs. Attached to the main line 52 may be hooks 55 via hook lines 54. The hook lines 54 may have a length in a range from about 2 inches to about 5 inches. Further, each hook line 54 may be the same length or varying lengths. The sinker snap 53 may facilitate the accommodation of sinkers on the main line 52.

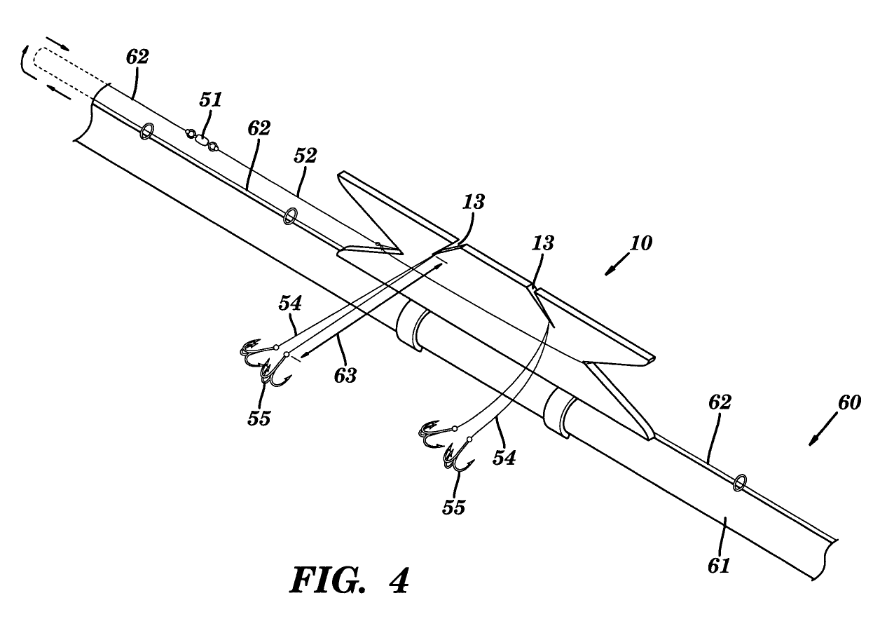

FIG. 4 depicts an embodiment of a perspective view of a securing element 10 in use, in accordance with the present invention. Referring to FIGS. 1-4, the securing element 10 may be fitted onto a fishing pole 60, specifically a fishing pole rod 61, via the element fittings 12. The fishing pole 60, by way of example, may have a bait rig 50 already attached to the fishing pole line 62 via a main line tie 51. The element 10 can be fitted onto any portion of the rod 61 between an end of the rod (not shown) and a fishing reel (not shown). Moreover, the element 10 may be attached to the pole rod 61 when the fishing pole 60 is ready to be stored with the bait rig 50 still attached.

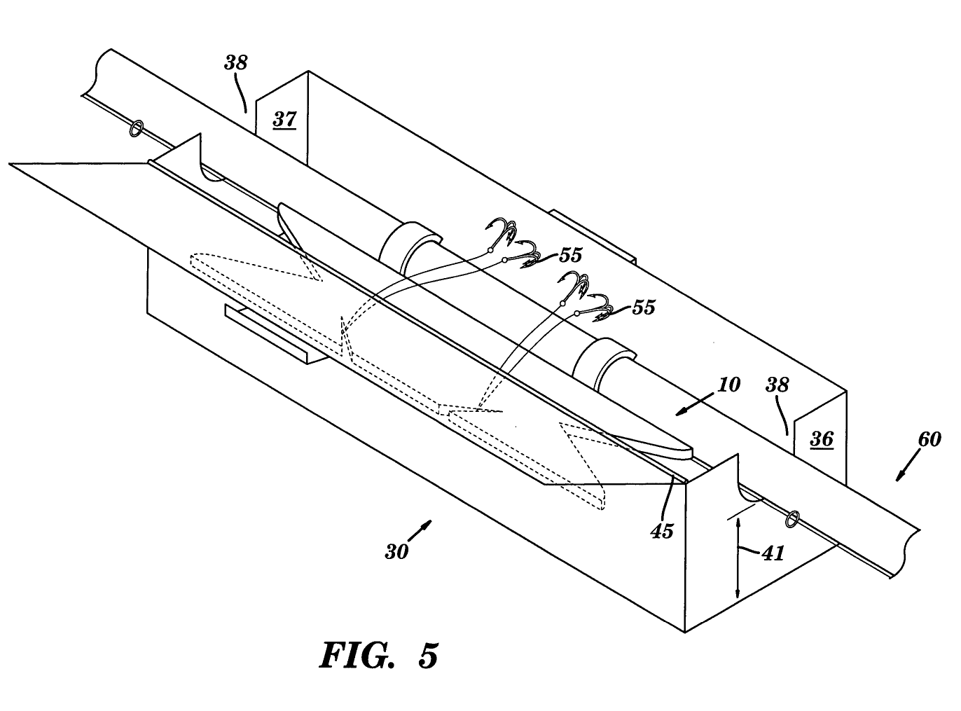

With the element 10 attached to the pole rod 61, the bait rig main line 52 as well as the bait rig hook lines 54 may be wrapped around the body 11. The lines 52 and 54 may be particularly wrapped around the indentations 16 and settle within the indentations 16 at the vertex of the angle 17. A chosen length 63 from the end of the line 52 and/or the lines 54 may be selected such that the length 63 is not wrapped around the body 11 but used to secure the bait rig 50 onto the securing element 10. The line 52 and/or the lines 54 may be secured on the element 10 by the line catches 13. The line 52 and/or the lines 54 may be pulled into the catches 13 such that line 52 and/or the lines 54 can not accidentally come undone, i.e. are securely fastened. The bait rig 50 of the fishing pole 60 may also be securely attached to the element 10 and both the pole 60 and the rig 50 may be readied for storage. FIG. 5 depicts an embodiment of a perspective view of a case 30 in use, in accordance with the present invention.

FIG. 6 depicts a second embodiment of a perspective view of the case 30 in use, in accordance with the present invention. Referring to FIGS. 1-6, after the securing element 10 has been fitted onto the fishing pole 60 and the bait rig 50 has been secured, both the pole 60 with the rig 50 can be placed into the case 30 for storage. The pole 60 may be placed in the case 30 such that the rod 61 rests in the case indentations 38 and, the securing element 10 and the rig 50 are within the length 41 of each side 36 and 37, i. e. within the cavity of the case 30. The hooks 55 of the rig 50 may rest on the side of the securing element 11 or on the bottom of the case 30 without worry of entanglement.

The panel 32 may then be rotated about the hinge 45 in a direction 46 to close the case 30. Accordingly, the portion of the fishing pole 60 having the securing element 10 and the bait rig 50 may be safely and securely stored for future use. Use of the devices, the securing element 10 and the case 30, and the methods described, may allow one to store a bait rig 50 still attached to the fishing pole 60 without entangling the hooks 55, the bait rig line 52, and the hook lines 54 with each other.

The foregoing description of the embodiments of this invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying claims.

I claim:

1. A securing device comprising:
a securing element having a body with a fitting, wherein said fitting of said securing element is removably attachable to a fishing pole.

2. The device of claim 1 further comprising:
a case removably attachable to said fishing pole, wherein said case encloses said securing element and a portion of said fishing pole.

3. The device of claim 1 further comprising:
a pair of indentations on the body;
at least one line catch; and
a bait rig having a plurality of hook lines, wherein the bait rig is wound around the pair of indentations and the plurality of hook lines are engaged with at least one line catch.

4. The device of claim 1 further comprising:
an indentation in the body for wrapping a bait rig line around.

5. The device of claim 4 further comprising:
an angle of 15-45 degrees formed by the indentation in the body.

6. The device of claim 1 wherein the body has a shape selected from the group consisting of obloids, trapezoids, rectangles, squares, ellipses, circles, and combinations thereof.

7. The device of claim 1 wherein the securing element fitting is a resilient member that snaps onto the portion of the fishing pole.

8. The device of claim 2 wherein the case further comprises:
an indentation that is a parabolic curved section to accept a fishing pole, wherein the indentation has a depth of 0.25-1.0 inches, and a width of 0.25-1.0 inches.

9. The device of claim 2 wherein the case is substantially rectangular having a bottom, two ends, a first side, a second side and a panel that is closeable.

10. The device of claim 9 wherein the case further comprises:
a pair of indentations located in each end of the case that is a parabolic curved section to accept a fishing pole, wherein the indentation has a depth of 0.25-1.0 inches, and a width of 0.25-1.0 inches.

11. The device of claim 9 wherein the case has a length of 4-7 inches, a width of 1-3 inches and a depth of 1-3 inches.

12. The device of claim 1 further comprising:
at least one line catch on the body.

13. A bait rig securing device comprising:
a case removably attachable to a fishing pole, said fishing pole having a bait rig attached and wherein said case encloses a portion of said fishing pole having said bait rig.

14. The device of claim 13 wherein the case has a length of 4-7 inches, a width of 1-3 inches and a depth of 1-3 inches.

15. The device of claim 13 wherein the case is substantially rectangular having a bottom, two ends, two sides and a panel that is closeable.

16. The device of claim 15 further comprising:
a lockable closure for the panel of the case selected from the group consisting of snap, hooks and loops, buckles or clasp.

17. The device of claim 2 further comprising:
a lockable handle on the case.

18. A method for storing bait rigs comprising the steps of:
providing a securing element, wherein said securing element is removably attachable to a fishing pole, said fishing pole having a bait rig attached;
attaching said securing element to a portion of said fishing pole;
securing said bait rig to said securing element;
providing a case removably attachable to said fishing pole; and
enclosing said securing element having said bait rig and the portion of said fishing pole having said securing element within said case.

19. The method of claim 18 further comprising the steps of:
locking a cover on the case.

20. The method of claim 18 further comprising the steps of:
winding said bait rig around said securing element.
